(19) United States
(12) Patent Application Publication
(10) Pub. No.: US 2024/0181672 A1
(43) Pub. Date: Jun. 6, 2024

(54) Method For Manufacturing Colored Fiber Body And Composite Body

(71) Applicant: SEIKO EPSON CORPORATION, Tokyo (JP)

(72) Inventors: Tetsuya AOYAMA, Shiojiri (JP); Tomoyuki USHIYAMA, Chino (JP); Xianmei LIU, Nagano (JP); Hiroaki KUMETA, Nagano (JP)

(21) Appl. No.: 18/527,437

(22) Filed: Dec. 4, 2023

(30) Foreign Application Priority Data
Dec. 5, 2022 (JP) 2022-194266

(51) Int. Cl. B27N 3/04; B27N 3/00; B27N 3/02; B27N 3/18; D04H 1/732

(52) U.S. Cl. CPC B27N 3/04; B27N 3/002; B27N 3/02; B27N 3/18; D04H 1/732

(57) ABSTRACT

A method for manufacturing a colored fiber body of the present disclosure includes a deposition step of depositing a mixture containing cellulose fibers and a composite body by an airflow, a humidifying step of humidifying the mixture; and a molding step of heating and pressurizing the humidified mixture to form a fiber body, and the composite body includes composite particles integrally containing a biological-derived colorant and a binding material to have a binding force to bind the cellulose fibers to each other by moisture application.

The present application is based on, and claims priority from JP Application Serial Number 2022-194266, filed Dec. 5, 2022, the disclosure of which is hereby incorporated by reference herein in its entirety.

### BACKGROUND

### 1. Technical Field

The present disclosure relates to a method for manufacturing a colored fiber body and a composite body.

### 2. Related Art

In recent years, reduction in consumption of underground resources, such as petroleum, has been increasingly and strongly demanded.

Although fiber bodies, such as paper and a pulp-molded body, are formed using biological-derived resources, such as wood, as main raw materials, as colorants to color the fiber bodies described above, many substances synthesized from underground resources have been used.

JP-A-2005-48293 has proposed, as a fiber body colored with a biological-derived colorant, a color liner manufactured by wet papermaking using a pulp colored with a natural pigment.

However, compared to a synthetic colorant, the biological-derived colorant may be inferior in terms of cost stability and supply stability in some cases. In addition, in recent years, the application of the biological-derived colorant has been rapidly expanded for food coloration, cloth dyeing, and the like, and hence, competition with food application of living organisms used as the raw material has been concerned. Accordingly, the biological-derived colorant is required to be used in a minimum necessary amount without waste. In view of the point described above, in the technique disclosed in the above patent document, since the natural pigment is added to a pulp slurry, and the paper is formed by a wet papermaking method, the natural pigment is only partially used for the paper coloration, and most of the natural pigment not used for the coloration is mixed with white water, that is, a waste liquid, generated in a papermaking process and is then discharged as the waste; hence, a use efficiency of the natural pigment has been low.

### SUMMARY

The present disclosure was made to overcome the problem described above and can be realized as the following application examples.

According to one application example of the present disclosure, there is provided a method for manufacturing a colored fiber body, comprising: a deposition step of depositing a mixture containing cellulose fibers and a composite body by an airflow; a humidifying step of humidifying the mixture; and a molding step of heating and pressurizing the humidified mixture to form a fiber body. In the method described above, the composite body includes composite particles which integrally contain a biological-derived colorant and a binding material to have a binding force to bind the cellulose fibers to each other by moisture application.

According to another application example of the present disclosure, there is provided a composite body used for manufacturing of a colored fiber body including cellulose fibers, and the composite body comprises composite particles which integrally contain a biological-derived colorant and a binding material to have a binding force to bind the cellulose fibers to each other by moisture application.

### BRIEF DESCRIPTION OF THE DRAWINGS

FIG. 1 is a schematic view showing a preferable embodiment of a composite body of the present disclosure.

FIG. 2 is a schematic side view showing the structure of an apparatus for manufacturing a colored fiber body according to a preferable embodiment.

FIG. 3 is a flowchart sequentially showing steps to be performed by the apparatus for manufacturing a colored fiber body shown in FIG. 2.

### DESCRIPTION OF EMBODIMENTS

Hereinafter, preferable embodiments of the present disclosure will be described in detail.

First, a method for manufacturing a colored fiber body and a composite body of the present disclosure will be described.

### 1. Method for Manufacturing Colored Fiber Body

A method for manufacturing a colored fiber body of the present disclosure includes a deposition step of depositing a mixture containing cellulose fibers and a composite body by an airflow, a humidifying step of humidifying the mixture; and a molding step of heating and pressurizing the humidified mixture to form a fiber body, in particular, to form a colored fiber body. In addition, the composite body includes composite particles which integrally contain a biological-derived colorant and a binding material to have a binding force to bind the cellulose fibers to each other by moisture application.

Accordingly, there can be provided a method for manufacturing a colored fiber body in which the colored fiber body as a molded body including the cellulose fibers and the biological-derived colorant can be preferably manufactured while waste of the biological-derived colorant generated in the manufacturing process is reduced. In particular, by using only a small amount of water, a colored fiber body having a desired shape can be preferably manufactured. That is, since only a small amount of water is used, the waste of the biological-derived colorant and the like generated when a large amount of the biological-derived colorant is incorporated in a waste liquid and the like can be effectively prevented. In addition, since the manufacturing method described above can be preferably applied to a dry molding method, for example, various advantages in terms of productivity and production cost of the colored fiber body, energy saving, reduction in size of manufacturing facilities for the colored fiber body, and the like can be obtained. In addition, in this specification, the dry molding method indicates a method in which in a process for manufacturing the colored fiber body, a raw material thereof is not immersed in a liquid including water, and a method using a small amount of water, such as a method to spray a liquid including water to the raw material of the colored fiber body or the like, is also included in the dry molding method.

In addition, by the structure as described above, a colored fiber body excellent in strength can be stably manufactured. In more particular, since the composite particles containing a binding material to have a binding force by moisture application are used, during the storage of the raw material of the colored fiber body and/or in the manufacturing process of the colored fiber body, the raw material of the colored fiber body can be effectively prevented from being unfavorably aggregated, and the colored fiber body can be stably manufactured. In addition, besides those described above, since the binding force can be obtained by moisture application through the humidification performed in the manufacturing process of the colored fiber body, the adhesion between the binding material and the cellulose fibers in the colored fiber body can be made excellent, and hence, the strength of the colored fiber body can be made excellent.

In addition, as described above, although the binding material may be a material to have a binding force to bind the cellulose fibers to each other by moisture application, “to have a binding force” in this case indicates that, compared to the case in which no moisture application is performed, the binding force is apparently increased, and for example, the case in which when no moisture application is performed, a relatively weak binding force is obtained is not excluded.

### 1-1. Deposition Step

In the deposition step, the mixture containing the cellulose fibers and the composite body is deposited by an airflow.

Although a mixing rate between the cellulose fibers and the composite body in this step is not particularly limited, a content of the composite body in the mixture obtained in this step is preferably 1 to 50 percent by mass, more preferably 2 to 45 percent by mass, and further preferably 3 to 40 percent by mass.

Accordingly, while a content rate of the cellulose fibers in a colored fiber body to be finally obtained is increased sufficiently high, the strength of the colored fiber body can be made more excellent. In addition, the transport of the composite body in the manufacturing process of the colored fiber body can be more smoothly performed.

In this step, the cellulose fibers to be mixed with the composite body may be processed in advance by a humidifying treatment, for example, before the humidifying step which will be described later, that is, before the step of performing a humidifying treatment to the mixture. In addition, the cellulose fibers may also be humidified sometime from the mixing with the composite body to the deposition of the mixture obtained by this mixing.

In the case as described above, a water content in the cellulose fibers to be subjected to this step is preferably 0.1 to 12 percent by mass, more preferably 0.2 to 10 percent by mass, and further preferably 0.3 to 9.0 percent by mass.

Accordingly, for example, before this step is performed, adverse influence of static electricity on the cellulose fibers, such as the adhesion of the cellulose fibers to a wall surface or the like of a manufacturing apparatus of the colored fiber body, can be effectively prevented, and the cellulose fibers and the composite body can be more uniformly mixed together.

### 1-1-1. Cellulose Fibers

The cellulose fibers are, in general, a main component of the colored fiber body manufactured using the method for manufacturing a colored fiber body of the present disclosure and are a component that not only largely contributes to the retention of the shape of the colored fiber body but also imparts a significant influence on the performance, such as the strength, of the colored fiber body.

In addition, since the cellulose fibers, which are abundant biological-derived resources, are used, the environmental problem, the saving of underground resources, and the like can be preferably dealt with, and in addition, the cellulose fibers are also preferably used in view of the stable supply of the colored fiber body, the cost reduction thereof, and the like. In addition, among various types of fibers, since having a particularly high theoretical strength, the cellulose fibers are advantageous in order to further improve the strength of the colored fiber body.

In general, although being primarily formed from cellulose, the cellulose fibers may contain a component other than the cellulose. As the component as described above, for example, a hemicellulose and/or a lignin may be mentioned.

In addition, as the cellulose fibers, cellulose fibers processed by a treatment, such as bleaching, may also be used.

In addition, the cellulose fibers may be fibers processed by a treatment, such as UV radiation, an ozone treatment, or a plasma treatment. Accordingly, the hydrophilicity of the cellulose fibers can be more enhanced, and the affinity to the binding material can be further increased.

Although an average length of the cellulose fibers is not particularly limited, the average length described above is preferably 0.1 to 50 mm, more preferably 0.2 to 5.0 mm, and further preferably 0.3 to 3.0 mm.

Accordingly, the shape stability, the strength, and the like of a colored fiber body to be manufactured can be made more excellent.

Although an average width of the cellulose fibers is not particularly limited, the average width described above is preferably 0.005 to 0.5 mm and more preferably 0.010 to 0.05 mm.

Accordingly, the shape stability, the strength, and the like of a colored fiber body to be manufactured can be made more excellent. In addition, unfavorable irregularity can be more effectively prevented from being generated on the surface of the colored fiber body.

Although an average aspect ratio of the cellulose fibers, that is, although the average length to the average width thereof, is not particularly limited, the average aspect ratio described above is preferably 10 to 1,000 and more preferably 15 to 500.

Accordingly, the shape stability, the strength, and the like of a colored fiber body to be manufactured can be made more excellent. In addition, unfavorable irregularity can be effectively prevented from being generated on the surface of the colored fiber body to be manufactured.

### 1-1-2. Composite Body

Hereinafter, a composite body used for manufacturing of the colored fiber body by mixing with the cellulose fibers, that is, the composite body of the present disclosure, will be described in detail.

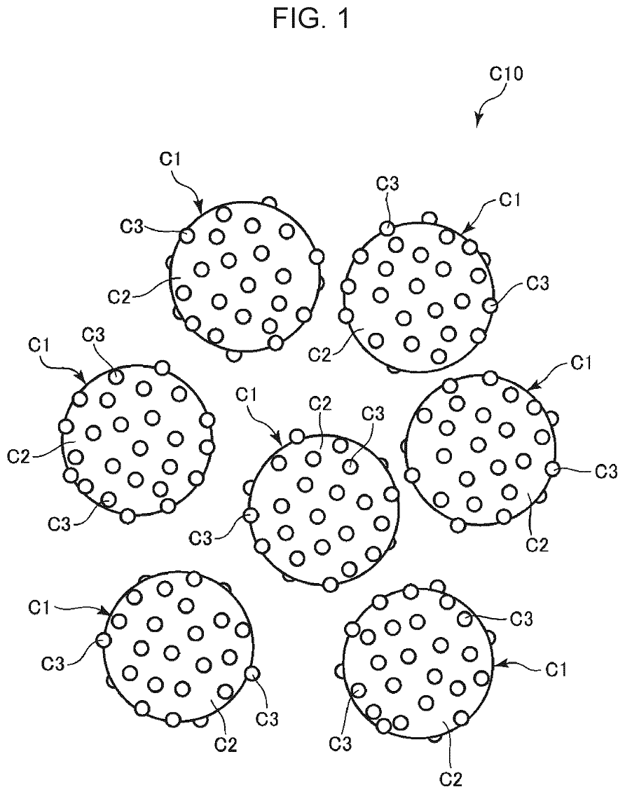

FIG. 1 is a schematic view showing a preferable embodiment of the composite body of the present disclosure.

A composite body C10 is used for manufacturing of the colored fiber body containing the cellulose fibers. In addition, the composite body C10 includes composite particles C1 which integrally contain a biological-derived colorant and a binding material to have a binding force to bind the cellulose fibers to each other by moisture application.

Accordingly, there can be provided a composite body which can be preferably used for a method for manufacturing a colored fiber body, the method being able to preferably manufacture a colored fiber body as a molded body including the cellulose fibers and the biological-derived colorant while waste of the biological-derived colorant generated in the manufacturing process is reduced. In particular, by using only a small amount of water, the composite body described above can be preferably used for a method capable of preferably manufacturing a colored fiber body having a desired shape. That is, since only a small amount of water is used, the waste of the biological-derived colorant and the like generated when a large amount of the biological-derived colorant is incorporated in a waste liquid and the like can be effectively prevented. In addition, since the composite body described above can be preferably applied to a dry molding method, various advantages in terms of productivity and production cost of the colored fiber body, energy saving, reduction in size of manufacturing facilities for the colored fiber body, and the like can be obtained.

In addition, the composite body described above can be used for stable manufacturing of a colored fiber body having an excellent strength. In more particular, since the composite particles containing a binding material to have a binding force by moisture application are used, during the storage of the raw material of the colored fiber body and/or in the manufacturing process of the colored fiber body, unfavorable aggregation can be effectively prevented in the raw material of the colored fiber body, and the colored fiber body can be stably manufactured. In addition, besides those described above, since the binding force can be obtained by moisture application through the humidification performed in the manufacturing process of the colored fiber body, the adhesion between the binding material and the cellulose fibers in the colored fiber body can be made excellent, and the strength of the colored fiber body can be made excellent.

### 1-1-2-1. Composite Particles

The composite particle C1 is a particle forming the composite body C10 and integrally contains a biological-derived colorant and a binding material to have a binding force to bind the cellulose fibers to each other by moisture application.

In particular, in the structure shown in the drawing, the composite particle C1 contains a binding material/colorant-containing particle C2 as a parent particle which integrally contains a binding material and a biological-derived colorant and inorganic particles C3 adhered to the surface of the above parent particle.

### 1-1-2-1-1. Binding Material/Colorant-Containing Particle

The binding material/colorant-containing particle C2 contains a biological-derived colorant and a binding material to have a binding force to bind the cellulose fibers to each other by moisture application.

### 1-1-2-1-1-1. Binding Material

As the binding material to form the composite particle C1, for example, there may be mentioned a natural material-derived component, such as a starch, a glycogen, an amylose, a hyaluronic acid, a konjak, a natural gum paste (an etherified tamarind gum, an etherified locust bean gum, an etherified guar gum, or an acacia arabic-based gum), a fiber-derived paste (an etherified carboxymethyl cellulose or an hydroxy ethylcellulose), seaweed (a sodium alginate or an agar), or an animal protein (such as a collagen, a gelatin, a hydrolyzed collagen, or a sericin), a poly(vinyl alcohol), a polyacrylic acid, or a polyacrylamide, and at least one of those mentioned above may be used alone, or at least two types thereof may be used in combination. However, the binding material is preferably a natural product-derived component, and a starch is more preferable.

Accordingly, while the use of a petroleum-derived material is suppressed, and a CO₂ emission amount is reduced, the excellent effect of the present disclosure as described above can be obtained. In addition, the materials as described above are also excellent in biodegradability.

In particular, when heating is performed after the moisture application, since being gelatinized, a starch preferably has a binding force, that is, a starch is a binding material to preferably have a binding force to bind the cellulose fibers to each other by moisture application. In addition, since a starch has a binding force by a non-covalent bond, such as a hydrogen bond, between cellulose fibers having hydroxy groups, has an excellent binding force to the cellulose fibers, and has an excellent coatability on the cellulose fibers, for example, the strength of the colored fiber body manufactured using the composite body C10 can be made more excellent.

The starch is a high molecular weight material formed by polymerization of α-glucose molecules with glycosidic bonds interposed therebetween.

The starch includes at least one of an amylose and an amylopectin.

In addition, as the starch, a processed starch or a modified starch may be used. As the processed starch, for example, there may be mentioned an esterified starch, such as an acetylated distarch adipate or an acetylated starch; an etherified starch, an oxidized starch, a starch sodium octenyl succinate, a hydroxypropyl starch, a hydroxypropyl distarch phosphate, a monostarch phosphate, a phosphated distarch phosphate, a starch urea phosphate, a sodium starch glycolate, or a high-amylose cornstarch. In addition, as the modified starch, for example, a pregelatinized starch, a dextrin, a lauryl polyglucose, a cationized starch, a thermoplastic starch, or a carbamic acid starch may be mentioned.

In addition, as the starch, for example, a kudzu powder or a potato starch may also be used.

In particular, the binding material is preferably a starch having a weight average molecular weight of 50,000 to 400,000.

Accordingly, a water absorption efficiency of the binding material can be made more excellent, and even when a moisture application amount is smaller, a colored fiber body having a sufficient strength can be manufactured. In more particular, even when a small amount of water is applied, the gelatinization is preferably advanced by heating, the productivity of the colored fiber body using the composite body C10 can be made excellent, and in addition, for example, the strength of a colored fiber body to be manufactured can also be made excellent. In addition, in particular, the starch having a predetermined molecular weight as described above is not likely to be unfavorably denatured by moisture application.

A starch controlled so as to have a weight average molecular weight in a predetermined range as described above can be preferably obtained, for example, by the following procedure. For example, after a natural starch is suspended in water, when a sulfuric acid, a hydrochloric acid, or a sodium hypochlorite solution is added thereto under conditions in which the starch is not gelatinized, a starch controlled to have a weight average molecular weight in a predetermined range can be obtained. In addition, for example, after a natural starch itself or a natural starch to which a small amount of a volatile acid, such as a hydrochloric acid, diluted with water is added is well mixed, ripened, and dried at a low temperature, heating is performed to 120° C. to 180° C., so that a starch controlled to have a weight average molecular weight in a predetermined range can be obtained. In addition, for example, when a treatment is performed such that a paste liquid obtained by heating a natural starch together with water is hydrolyzed by an acid or an enzyme, a starch controlled to have a weight average molecular weight in a predetermined range can be preferably obtained.

As described above, the weight average molecular weight of the starch functioning as the binding material is preferably 50,000 to 400,000, more preferably 70,000 to 300,000, and further preferably 80,000 to 200,000.

Accordingly, the effect described above can be more significantly obtained.

In addition, the weight average molecular weight of the starch can be obtained by measurement using a gel permeation chromatography. A weight average molecular weight shown in Example which will be described later is also a value obtained by measurement using a gel permeation chromatography.

A content rate of the binding material in the binding material/colorant-containing particles C2 is preferably 40 percent by mass or more, more preferably 80 percent by mass or more, further preferably 90 percent by mass or more, and particularly preferably 95 percent by mass or more.

Accordingly, while the color density of a colored fiber body to be manufactured can be made sufficiently high, the strength thereof can also be made more excellent.

### 1-1-2-1-1-2. Biological-Derived Colorant

The composite particle C1, in particular, the binding material/colorant-containing particle C2, contains a biological-derived colorant. In the present disclosure, a “biological-derived” material includes not only a component directly obtained from a living organism but also a derivative of a component directly obtained from a living organism. In addition, although a fossil fuel, such as petroleum, can also be regarded as a biological-derived material in consideration of its origin, in the present disclosure, a material derived from a fossil fuel is not included in the biological-derived material.

As the biological-derived colorant, for example, a chromatic colorant and an achromatic colorant may be mentioned, and among those mentioned above, at least one selected from the group consisting of a vegetable carbon black and a biological-derived chromatic colorant, both of which will be described later, is included.

In addition, in this specification, the “chromatic color” indicates a color having a saturation (C* value) of 1.0 or more by a CIELAB measurement using a colorimeter which is performed on a test pattern formed such that a minimum amount of ink necessary to cover the entire recording medium surface of a white recording medium, such as high-quality paper, is adhered thereto. On the other hand, the “achromatic color” colorant indicates a colorant which shows a white color, a black color, or a color obtained by mixing white and black each of which has a saturation of less than 1.0.

The biological-derived colorant may be either water soluble or water insoluble.

In a related wet papermaking method, when a water soluble colorant is used, the colorant is dissolved in a pulp slurry, and a use efficiency of the colorant may be seriously degraded in some cases, and in addition, there has been a problem in that a colorant capable of dyeing cellulose fibers is only used. On the other hand, according to the present disclosure, even when a water soluble colorant is used, the problem as described above can be sufficiently prevented from being generated, an effect to improve the use efficiency of the colorant is significantly obtained, and a dye having an inferior dyeing property to cellulose fibers can also be used.

In a related wet papermaking method, when a water insoluble colorant is used, in the case in which the colorant described above is added so as to be dispersed in a pulp slurry, there has been a problem in that the colorant is liable to be separated from a colored fiber body to be finally obtained. On the other hand, according to the present disclosure, even when a water insoluble colorant is used, since the composite particles integrally containing the colorant and the binding material are used, the binding material is bound to the fibers in a colored fiber body to be manufactured, and hence, the colorant is not likely to be separated from the colored fiber body.

In this specification, the “water insolubility” indicates a water solubility of 0.1 g/100 g of water or less at 20° C., and the “water solubility” indicates a water solubility of more than 0.1 g/100 g of water at 20° C.

As a chromatic colorant as the biological-derived colorant, for example, a flavonoid-based pigment, a quinoid-based pigment, a carotenoid-based pigment, or a pigment derived from another living organism may be mentioned.

As the flavonoid-based pigment, for example, a safflower red pigment, a safflower yellow pigment, a turmeric pigment, a cacao pigment, a tamarind pigment, a persimmon pigment, or a kaoliang pigment may be mentioned. As the quinoid-based pigment, for example, a cochineal pigment, a lac pigment, or a madder pigment may be mentioned. As the carotenoid-based pigment, for example, β-carotene, a gardenia pigment, a garden pepper pigment, an annatto pigment (Bixa orellana pigment), a marigold pigment, or a tomato pigment may be mentioned. As a pigment derived from another living organism, for example, a chlorophyll pigment, a monascus pigment, an indigo blue, or a beet red pigment may be mentioned. In addition, a betanin-based pigment, such as a red beet pigment (beet red pigment); an anthocyanin-based pigment, such as a red cabbage pigment, a purple potato pigment, a red radish pigment, a grape skin pigment, a perilla pigment, an elderberry pigment, or a purple corn pigment; or a phycocyanin-based pigment, such as a spirulina pigment, may also be used.

As an achromatic colorant as the biological-derived colorant, for example, a vegetable carbon black or a squid ink pigment may be mentioned. As the vegetable black ink, for example, Bincho charcoal, bamboo charcoal, activated charcoal, white charcoal, black charcoal, molded charcoal, sawdust briquette charcoal, plum charcoal, mangrove charcoal, rice husk briquette charcoal, or coconut shell charcoal may be mentioned. The vegetable carbon black is preferably at least one selected from the group consisting of Bincho charcoal and bamboo charcoal. Accordingly, a color development property of the colored fiber body can be improved.

In addition, as the biological-derived colorant, a colorant excellent in heat resistance is preferably used. In particular, a colorant having a heat resistance so as to withstand a heating temperature in the manufacturing process of the colored fiber body is preferable, and in more particular, for example, a colorant having a heat resistance of 80° C. or more is preferably used.

As the colorant having a heat resistance as described above, for example, the following may be mentioned. That is, as a yellow-based colorant having a heat resistance, for example, a turmeric pigment, a gardenia yellow pigment, a safflower yellow pigment, β-carotene, a marigold pigment, a garden pepper pigment, or an annatto pigment may be mentioned. In addition, as a red-based colorant having a heat resistance, for example, a lac pigment, a cochineal pigment, a monascus pigment, a red cabbage pigment, a gardenia red pigment, a purple potato pigment, a red radish pigment, a grape skin pigment, a perilla pigment, a safflower red pigment, or a tomato pigment may be mentioned. In addition, as a blue-based colorant having a heat resistance, for example, a gardenia blue pigment, a chlorella powder, a chlorophyll, or an indigo blue may be mentioned. In addition, as a black-based colorant having a heat resistance, for example, a squid ink pigment, or a vegetable carbon black, such as bamboo charcoal, Bincho charcoal, sawdust briquette charcoal, coconut shell charcoal, or rice husk briquette charcoal may be mentioned. In addition, as a brown-based colorant having a heat resistance, for example, a cacao pigment, a tamarind pigment, a persimmon pigment, a kaoliang pigment, a caramel pigment, or a malt extract pigment may be mentioned.

A content of the biological-derived colorant in the composite body C10 is preferably 1.0 to 50.0 percent by mass, more preferably 3.0 to 15.0 percent by mass, and further preferably 5.0 to 11.0 percent by mass.

Accordingly, while the strength of a colored fiber body to be manufactured is made sufficiently excellent, the color density of the colored fiber body can be made particularly high.

### 1-1-2-1-1-3. Dispersant

For example, when the biological-derived colorant is water insoluble, the composite particle C1, in particular, the binding material/colorant-containing particle C2, may further contain a dispersant for the biological-derived colorant.

Accordingly, uniformity of the colorant and the binding material in the composite particle C1 can be made more excellent, and unfavorable composition irregularity can be more effectively suppressed. As a result, unfavorable coloring irregularity in a colored fiber body to be finally obtained can be more effectively prevented.

Although the dispersant as described above may not be a biological-derived dispersant, the dispersant is preferably a biological-derived dispersant.

Accordingly, while the effect achieved by the use of the dispersant as described above is obtained, the use of underground resources can be more effectively suppressed.

As the biological-derived dispersant, for example, there may be mentioned a polyglycerin fatty acid ester, such as a lignin sulfonate salt, a modified lignin, a lecithin, a lecithin derivative, an enzyme-treated lecithin, a saponin, a plant sterol, a glycerin fatty acid ester, or a decaglyceryl myristic acid ester, a polyoxyethylene glycerin fatty acid ester, a sucrose fatty acid ester, a sorbitan fatty acid ester, a propylene glycol fatty acid ester, or a polyoxyethylene alkyl ether.

Among those mentioned above, at least one selected from the group consisting of a lignin sulfonate salt, a lecithin, a glycerin fatty acid ester, and a polyglycerin fatty acid ester is preferable. The lignin sulfonate salt includes a sodium salt and a magnesium salt, and in order to reduce the particle diameter of the colorant, a sodium salt is preferable.

Accordingly, an interaction with the biological-derived colorant described above is made more excellent, and the effect described above can be more significantly obtained.

When the composite particle C1, in particular, the binding material/colorant-containing particle C2, contains a dispersant, a content of the dispersant in the composite body C10 is preferably 3.0 to 20.0 percent by mass, more preferably 4.0 to 18.0 percent by mass, and further preferably 5.0 to 16.0 percent by mass.

Accordingly, while the effect achieved by containing the binding material as described above, the effect achieved by containing the biological-derived colorant, and in particular, the effect achieved by containing a water insoluble colorant are sufficiently obtained, the effect achieved by containing the dispersant can be more significantly obtained.

In the case in which the composite particle C1, in particular, the binding material/colorant-containing particle C2, contains a dispersant, when a content of the biological-derived colorant in the composite body C10 is represented by XC1 [percent by mass], and a content of the dispersant in the composite body C10 is represented by XD [percent by mass], 0.2≤XD/XC1≤2.0 is preferably satisfied, 0.7≤XD/XC1≤1.8 is more preferably satisfied, and 0.9≤XD/XC1≤1.6 is further preferably satisfied.

Accordingly, unfavorable coloring irregularity in a colored fiber body to be finally obtained can be effectively prevented, and in addition, the strength of the colored fiber body can be made more excellent.

1-1-2-1-1-4. Colorant Other than Biological-Derived Colorant

The composite particle C1, in particular, the binding material/colorant-containing particle C2, may further contain, besides the biological-derived colorant, at least one colorant other than the biological-derived colorant.

When the composite particle C1, in particular, the binding material/colorant-containing particle C2, contains at least one colorant other than the biological-derived colorant, a content of the at least one colorant in the composite body C10 is preferably 0.1 to 5.0 percent by mass, more preferably 0.2 to 4.0 percent by mass, and further preferably 0.3 to 3.0 percent by mass.

In the case in which the composite particle C1, in particular, the binding material/colorant-containing particle C2, contains at least one colorant other than the biological-derived colorant, when a content of the biological-derived colorant in the composite body C10 is represented by XC1 [percent by mass], and a content of the at least one colorant other than the biological-derived colorant is represented by XC2 [percent by mass], 0.007≤XC2/XC1≤0.99 is preferably satisfied, 0.016≤XC2/XC1≤0.80 is more preferably satisfied, and 0.028≤XC2/XC1≤0.50 is further preferably satisfied.

### 1-1-2-1-1-5. Plasticizer

The composite particle C1, in particular, the binding material/colorant-containing particle C2, may further contain a plasticizer.

Accordingly, even when being repeatedly melted and solidified, the composite particle C1 is not likely to be denatured, and hence, recycle characteristics of the colored fiber body can be made more excellent.

The plasticizer as described above may be a non-biological-derived material but is preferably a biological-derived material.

Accordingly, while the effect of the plasticizer as described above is obtained, the use of underground resources can be more effectively suppressed.

As the plasticizer, for example, there may be preferably used a compound having a plurality of functional groups in its molecule which are able to form hydrogen bonds with functional groups of the binding material such as a starch.

As the functional group which can be able to form a hydrogen bond, for example, a hydroxy group, an amino group, or a carboxy group may be mentioned.

As a concrete example of the plasticizer, for example, there may be mentioned a glycol, such as glycerin, ethylene glycol, propylene glycol, diethylene glycol, triethylene glycol, a polyethylene glycol, butylene glycol, a polyglycerin, or thioglycol; a saccharide, such as glucose, fructose, sucrose, galactose, maltose, lactose, starch syrup, trehalose, or maltose; a sugar alcohol, such as sorbitol, maltitol, xylitol, reduced starch syrup, erythritol, mannitol, lactitol, or palatinit; a sugar derivative such as sucralose; a hydroxy acid such as tartaric acid; a polyalcohol, such as a poly(vinyl alcohol), trehalose, a polyhydroxy (meth)acrylate, or a hyaluronic acid; a polyamine, such as urea or thiourea; a polycarboxylic acid such as a hyaluronic acid; or a polyvinylpyrrolidone. Those mentioned above may be used alone, or at least two types thereof may be used in combination.

In particular, the plasticizer preferably includes at least one selected from the group consisting of a polyalcohol, a polyamine, and a polycarboxylic acid, a sugar alcohol is more preferable, and erythritol is further preferable.

Accordingly, for example, when a relatively large amount of water is applied to the colored fiber body thus manufactured, the plasticizer is dissolved, and a porous body having many voids each having a relatively large space between the cellulose fibers is formed. As a result, the biodegradability of the colored fiber body can be improved.

When the composite particle C1, in particular, the binding material/colorant-containing particle C2, contains a plasticizer, a content of the plasticizer in the composite body C10 is preferably 5.0 to 65.0 percent by mass, more preferably 10.0 to 60.0 percent by mass, and further preferably 20.0 to 55.0 percent by mass.

Accordingly, while the effect achieved by containing the binding material as described above and the effect achieved by containing the biological-derived colorant can be sufficiently obtained, the effect achieved by containing the plasticizer can be more significantly obtained.

In the case in which the composite particle C1, in particular, the binding material/colorant-containing particle C2, contains a plasticizer, when a content of the binding material in the composite body C10 is represented by XB [percent by mass], and a content of the plasticizer in the composite body C10 is represented by XP [percent by mass], 0.10≤XP/XB≤3.2 is preferably satisfied, 0.20≤XP/XB≤2.3 is more preferably satisfied, and 0.40≤XP/XB≤1.5 is further preferably satisfied.

Accordingly, while the effect achieved by containing the binding material as described above and the effect achieved by containing the biological-derived colorant can be sufficiently obtained, the effect achieved by containing the plasticizer can be more significantly obtained.

### 1-1-2-1-1-6. Other Components

The composite particle C1, in particular, the binding material/colorant-containing particle C2, may further contain at least one component other than those described above. Hereinafter, in this item, the at least one component as described above may also be called “other components” in some cases.

As the other components, for example, a fiber material, an aggregation inhibitor, and/or a flame retardant may be mentioned, and those mentioned above may be used alone, or at least two types thereof may be used in combination.

However, a content of the other components in the composite particle C1 is preferably 10.0 percent by mass or less, more preferably 7.0 percent by mass or less, and further preferably 5.0 percent by mass or less.

### 1-1-2-1-1-7. Other Conditions

An average particle diameter of the binding material/colorant-containing particle C2 is preferably 1.0 to 50 μm, more preferably 3.0 to 40 μm, and further preferably 5.0 to 30 μm.

Accordingly, the cellulose fibers and the composite body C10 can be more uniformly mixed together, moisture absorption in the humidifying step is more smoothly performed, and as a result, the strength and the reliability of a colored fiber body to be finally obtained can be made more excellent. In addition, as described above, when the particle diameter of the binding material/colorant-containing particle C2 is relatively small, a ratio of the surface area of the binding material/colorant-containing particle C2 to the mass thereof is increased, and a moisture absorption efficiency by the binding material can be made more excellent. As a result, even when a moisture application amount is smaller, a colored fiber body having a sufficient strength can be manufactured. In addition, fluidity of the composite body C10 and handleability thereof can be further improved.

In addition, in this specification, unless otherwise particularly noted, the average particle diameter indicates a median diameter (D50 value at a cumulative frequency of 50%). The average particle diameter may be obtained by measurement, for example, using a Microtrac UPA (manufactured by Nikkiso Co., Ltd.).

Although the binding material/colorant-containing particle C2 may be formed by an arbitrary method, as a method for manufacturing the binding material/colorant-containing particles C2, for example, there may be mentioned an immersion method in which the biological-derived colorant is immersed in a composition containing the binding material, a kneading method in which a composition containing the binding material and the biological-derived colorant is kneaded, or a spray dry method in which a liquid composition containing the binding material and the biological-derived colorant is sprayed and dried.

### 1-1-2-1-2. Inorganic Particles

Although the composite particle C1 may be a particle integrally containing the binding material and the biological-derived colorant, in the structure shown in the drawing, the composite particle C1 is a particle further containing inorganic particles. In more detail, the composite particle C1 shown in the drawing is a particle containing the binding material/colorant-containing particle C2 as a parent particle which contains the binding material and the biological-derived colorant and inorganic particles C3 adhered to the surface of the parent particle.

Accordingly, compared to the case in which no inorganic particles C3 are contained, for example, during the storage of the composite body C10, the transport of the composite body C10 in the manufacturing process of the colored fiber body, and the like, unfavorable aggregation of the composite particles C1 can be effectively prevented, and in the manufacturing process of the colored fiber body, the cellulose fibers and the composite particles C1 can be more uniformly mixed together. As a result, unfavorable irregularity in content rate of each component in a colored fiber body to be manufactured can be suppressed, and the strength and the reliability of the colored fiber body can be made more excellent.

Although the composite particle C1 contained in the composite body C10 may be a particle in which one inorganic particle C3 is adhered to the surface of one binding material/colorant-containing particle C2, the composite body C10 preferably contains, as the composite particle C1, a particle in which a plurality of inorganic particles C3 is adhered to the surface of one binding material/colorant-containing particle C2.

Accordingly, the effect as described above can be more significantly obtained.

The inorganic particles C3 have an average particle diameter of preferably 1 to 20 nm and more preferably 5 to 18 nm.

Accordingly, the effect achieved by containing the inorganic particles C3 as described above can be more significantly obtained. In addition, excess irregularity can be preferably prevented from being generated on the surface of the composite particle C1 in which the inorganic particles C3 are adhered to the surface of the binding material/colorant-containing particle C2, and the fluidity of the composite body C10 can be made more excellent. In addition, the inorganic particles C3 can be more preferably adhered to the surface of the binding material/colorant-containing particle C2, and the inorganic particles C3 can be preferably prevented from unfavorably falling from the surface of the binding material/colorant-containing particle C2 and/or from unfavorably being buried in the binding material/colorant-containing particle C2; hence, the effect as described above can be more significantly obtained.

In the composite body C10, although inorganic particles C3 not adhered to the binding material/colorant-containing particle C2, in other words, inorganic particles C3 forming no composite particle C1, may be contained, a rate of the inorganic particles C3 forming the composite particle C1 to all the inorganic particles C3 contained in the composite body C10 is preferably 50 percent by mass or more, more preferably 60 percent by mass or more, and further preferably 70 percent by mass or more.

Accordingly, the effect described above can be more significantly obtained.

The inorganic particles C3 may be primarily formed from an inorganic material. In addition, the inorganic particle C3 may have substantially a uniform composition in each portion or may have portions having different compositions.

In more particular, for example, the inorganic particles C3 may be obtained in a manner such that mother particles are surface-treated by at least one type of surface treatment agent. In other words, the inorganic particle C3 may include a mother particle formed from an inorganic material and a cover layer formed by a surface treatment agent to cover the mother particle.

Accordingly, for example, unfavorable aggregation of the binding material/colorant-containing particles C2 is further effectively prevented, and wet spreadability of the binding material on the cellulose fiber surface can be made more preferable in the molding step; hence, the strength of a colored fiber body to be finally obtained can be made more excellent.

Hereinafter, the case in which the composite body C10 includes, as the inorganic particle C3, a mother particle formed from an inorganic material and a cover layer formed by a surface treatment agent to cover the mother particle will be primarily described.

### 1-1-2-1-2-1. Mother Particle

The mother particle of the inorganic particle C3, in other words, a mother material of the inorganic particle C3 surface-treated by a surface treatment agent, is formed from an inorganic material.

Accordingly, a heat resistance of the inorganic particle C3 can be made more excellent, and the effect as described above can be more reliably obtained.

As a constituent material of the mother particle of the inorganic particle C3, for example, various types of metal materials, various types of metal compounds, various types of glass materials, and various types of carbon materials may be mentioned.

As the meta material, for example, a single metal, such as Fe, Al, Cu, Ag, or Ni, or an alloy containing at least one of those metals may be mentioned.

As the metal compound, for example, a metal oxide, a metal nitride, a metal carbide, or a metal sulfide may be mentioned, and in more particular, a silica, an alumina, a zirconia, a titanium oxide, a magnetite, or a ferrite may be mentioned.

As the glass material, for example, soda glass, crystalline glass, quartz glass, lead glass, potassium glass, borosilicate glass, or non-alkali glass may be mentioned.

As the carbon material, for example, a diamond, a carbon fiber, a carbon black, a carbon nanotube, a carbon nanofiber, or a fullerene may be mentioned.

Among those mentioned above, as the constituent material of the mother particle of the inorganic particle C3, a silica is preferable. In other words, the inorganic particles C3 is preferably a particle formed from a material containing a silica.

Accordingly, the surface treatment can be preferably performed on the mother particle using a surface treatment agent, and the adhesion between the mother particle and the surface treatment agent can be made more excellent. As a result, the effect as described above can be more significantly obtained. In addition, the silica is a material not likely to impart an adverse influence on the color of the colored fiber body manufactured using the composite body C10. In particular, when the colored fiber body is paper, the effect as described above can be more significantly obtained.

The mother particle of the inorganic particle C3 may be primarily formed from the inorganic material described above and may also contain, besides the above inorganic material, an organic material.

However, a content of the inorganic material occupied in the mother particle of the inorganic particle C3 is preferably 90 percent by mass or more, more preferably 92 percent by mass or more, and further preferably 95 percent by mass or more.

### 1-1-2-1-2-2. Surface Treatment Agent

As described above, the inorganic particle C3 preferably has a mother particle formed from an inorganic material and a cover layer formed by a surface treatment agent to cover the mother particle.

As a preferable surface treatment agent, for example, a fluorine-containing compound or a silicon-containing compound may be mentioned. Since the surface treatment agent as described above is used, the aggregation of the binding material/colorant-containing particles C2 and that of the composite particles C1 can be preferably prevented. In addition, since the inorganic particles C3 surface-treated by the surface treatment agent as described above are contained, the fluidity of the composite body C10 and the handleability thereof are improved. Accordingly, the productivity of the colored fiber body can be made particularly excellent. In addition, surface free energy of the inorganic particle C3 can be efficiently decreased. As a result, in the molding step, the composite body C10 is likely to more preferably wet-spread on the surface of the cellulose fibers. Accordingly, in a colored fiber body to be finally obtained, the adhesion between the binding material and the cellulose fibers can be made more excellent, and the strength of the colored fiber body can also be made more excellent.

As the fluorine-containing compound, for example, a perfluoropolyether or a fluorine-modified silicone oil may be mentioned.

In addition, as the silicon-containing compound, for example, various types of silicone oils, such as a polydimethylsiloxane having a trimethylsilyl terminal, a polydimethylsiloxane having a hydroxy terminal, a polymethylphenylsiloxane, an amino-modified silicone oil, an epoxy-modified silicone oil, a carboxy-modified silicone oil, a carbinol-modified silicone oil, a polyether-modified silicone oil, and an alkyl-modified silicone oil, may be mentioned.

Among those mentioned above, as the surface treatment agent, a polydimethylsiloxane having a trimethylsilyl terminal is preferable. In other words, the inorganic particle C3 is preferably a particle having a trimethylsilyl group on its surface.

Accordingly, the composite particle C1, the binding material/colorant-containing particle C2, and the inorganic particle C3 can be more effectively prevented from being aggregated.

When the surface treatment agent is used, one surface treatment agent may be used alone, or at least two types of surface treatment agents may be used in combination.

When at least two types of surface treatment agents are used, at least two types of surface treatment agents may be used on each mother particle, or the composite body C10 may include as the inorganic particles C3, particles treated by surface treatment agents different from each other.

A content of the surface treatment agent with respect to 100 parts by mass of the mother particles of the inorganic particles C3 included in the composite body C10 is preferably 0.5 to 7 parts by mass and more preferably 1 to 5 parts by mass.

Accordingly, the effect as described above can be more significantly obtained.

### 1-1-2-1-3. Other Conditions

An average particle diameter of the composite particle C1 is preferably 1.0 to 50 μm, more preferably 2.0 to 45 μm, and further preferably 3.0 to 40 μm.

Accordingly, the effect as described above can be more significantly obtained.

### 1-1-2-2. Other Constituents

The composite body C10 may further contain, besides the composite particles C1 described above, other constituents. For example, the composite body C10 may contain, besides the composite particles C1 described above, inorganic particles C3 not adhered to the binding material/colorant-containing particle C2 and/or particles containing a binding material and no biological-derived colorant.

However, a content of the composite particles C1 in the composite body C10 is preferably 50 percent by mass or more, more preferably 70 percent by mass or more, and further preferably 80 percent by mass or more.

Accordingly, the effect as described above can be more significantly obtained.

### 1-1-2-3. Other Conditions

The composite body C10 preferably satisfies the following conditions.

For example, a content of the binding material/colorant-containing particles C2 in the composite body C10 is preferably 90.0 to 99.9 percent by mass, more preferably 95.0 to 99.7 percent by mass, and further preferably 97.0 to 99.4 percent by mass.

Accordingly, the effect as described above can be more significantly obtained.

In addition, a content of the inorganic particles C3 in the composite body C10 is preferably 0.1 to 10.0 percent by mass, more preferably 0.3 to 5.0 percent by mass, and further preferably 0.6 to 3.0 percent by mass.

Accordingly, the effect obtained by containing the inorganic particles C3 as described above can be more significantly obtained, and for example, the fluidity of the composite body C10 can be made more excellent, and the strength of a colored fiber body to be finally obtained can be made more excellent.

### 1-2. Humidifying Step

In the humidifying step, the mixture thus deposited, that is, a mixture containing the cellulose fibers and the composite body C10, is humidified.

Accordingly, in the following molding step, a bonding strength between the binding material and the cellulose fibers, and a bonding strength between the cellulose fibers with the starch interposed therebetween can be made excellent, and for example, the strength of a colored fiber body to be finally obtained can be made sufficiently excellent. In addition, molding in the molding step can be preferably performed under relatively moderate conditions.

Although a method to humidify the mixture described above is not particularly limited, the method is preferably performed without contact to the mixture, and for example, there may be mentioned a method in which the mixture is placed in a high-humidity environment, a method in which the mixture is allowed to pass through a high humid space, a method in which mist of a liquid including water is sprayed on the mixture, or a method in which the mixture is allowed to pass through a space in which mist of a liquid including water is floating. In addition, one of the methods described above may be used alone, or at least two types thereof may be used in combination. In more particular, the humidification of the mixture described above can be performed using various types of humidifiers, such as a vapor type or an ultrasonic type humidifier. The humidification of the mixture may be performed at a plurality of stages, for example, in a process for manufacturing the colored fiber body. In addition, in the liquid including water, for example, an antiseptic agent, a fungicide, and/or an insecticide may also be contained.

### 1-3. Molding Step

In the molding step, the mixture humidified in the humidifying step is heated and pressurized. Accordingly, the colored fiber body can be obtained. In addition, the humidifying step and the molding step may be simultaneously performed.

A water content in the mixture to be subjected to the molding step is preferably 12 to 40 percent by mass, more preferably 13 to 38 percent by mass, and further preferably 15 to 35 percent by mass.

Accordingly, compared to a related papermaking method, a colored fiber body having a sufficient strength can be manufactured using an extremely small amount of water, and the effect of the present disclosure can be more significantly obtained.

Although a heating temperature in the molding step is not particularly limited, the heating temperature is preferably 60° C. to 250° C., more preferably 70° C. to 200° C., and further preferably 80° C. to 170° C.

Accordingly, while unfavorable degradation, denaturation, and the like of the cellulose fibers and the constituent components of the composite body C10 are effectively prevented, the composite body C10 is able to preferably wet-spread on the surface of the cellulose fibers. As a result, the strength and the reliability of a colored fiber body to be manufactured can be made more excellent. In addition, the heating temperature described above is also preferable in view of energy saving. In particular, when the composite body C10 is formed using a material containing a starch as the binding material, a starch absorbing water can be preferably gelatinized, and in addition, for example, the constituent materials of the colored fiber body can be effectively prevented from being unfavorably degraded.

Although a pressure to be applied to the mixture in the molding step is not particularly limited, the pressure described above is preferably 0.1 to 100 MPa and more preferably 0.3 to 80 MPa.

Accordingly, the composite body C10 is able to more preferably wet-spread on the surface of the cellulose fibers. As a result, the strength of a colored fiber body to be manufactured can be made more excellent.

This step can be performed, for example, using a heat press, a heat roller machine, or the like.

The method for manufacturing a colored fiber body of the present disclosure can be preferably performed, for example, using the following apparatus for manufacturing a colored fiber body.

### 2. Apparatus for Manufacturing Colored Fiber Body

Next, an apparatus for manufacturing a colored fiber body according to the present disclosure will be described.

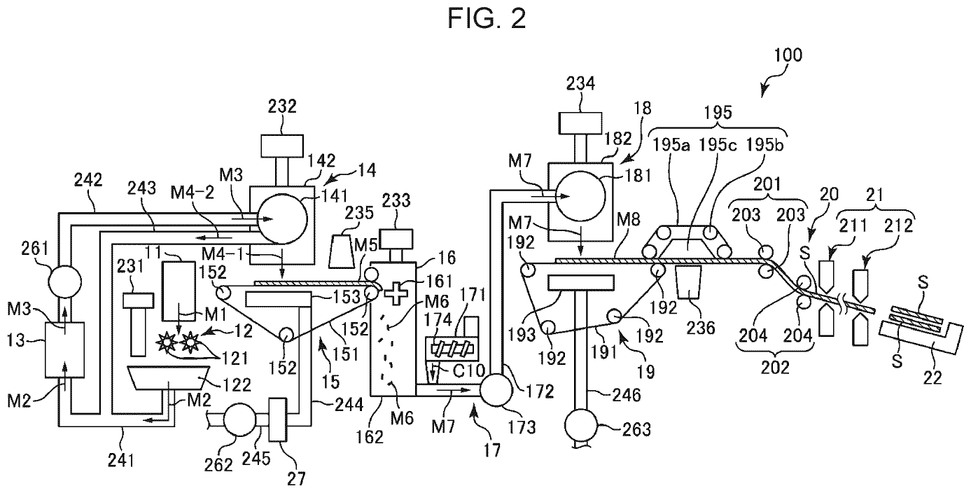

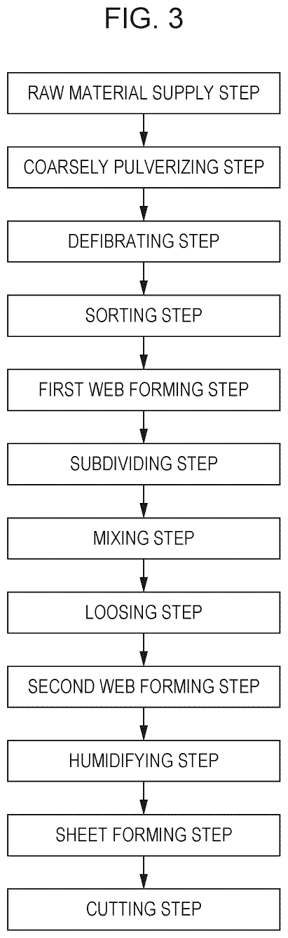

FIG. 2 is a schematic side view showing the structure of an apparatus for manufacturing a colored fiber body of a preferable embodiment. FIG. 3 is a flowchart sequentially showing steps to be performed by the apparatus for manufacturing a colored fiber body shown in FIG. 2. In addition, hereinafter, for the convenience of illustration in FIG. 2, an upper side is represented by “over” or “above”, a lower side is represented by “under” or “below”, a left side is represented by “left” or “upstream”, and a right side is represented by “right” or “downstream” in some cases.

In the following description, as one example of the apparatus for manufacturing a colored fiber body, a sheet manufacturing apparatus for manufacturing a sheet as the colored fiber body will be described.

As shown in FIG. 2, a sheet manufacturing apparatus 100 functioning as the apparatus for manufacturing a colored fiber body includes a raw material supply portion 11, a coarsely pulverizing portion 12, a defibrating portion 13, a sorting portion 14, a first web forming portion 15, a subdividing portion 16, a mixing portion 17, a loosing portion 18, a second web forming portion 19, a sheet forming portion 20, a cutting portion 21, and a stock portion 22. In addition, in the sheet manufacturing apparatus 100, a humidifying portion 231, a humidifying portion 232, a humidifying portion 233, and a humidifying portion 234 are provided.

The operation of each portion included in the sheet manufacturing apparatus 100 is controlled by a control portion not shown in the drawing.

As shown in FIG. 3, in this embodiment, a method for manufacturing a sheet as a colored fiber body includes a raw material supply step, a coarsely pulverizing step, a defibrating step, a sorting step, a first web forming step, a subdividing step, a mixing step, a loosing step, a second web forming step, a humidifying step, a sheet forming step, and a cutting step. In addition, the sheet manufacturing apparatus 100 can perform those steps in this order.

Hereinafter, the structures of the respective portions of the sheet manufacturing apparatus 100 will be described.

The raw material supply portion 11 is a portion to perform the raw material supply step of supplying a sheet-shaped material M1 to the coarsely pulverizing portion 12. As this sheet-shaped material M1, a sheet-shaped material containing cellulose fibers is used.

The coarsely pulverizing portion 12 is a portion to perform the coarsely pulverizing step of coarsely pulverizing the sheet-shaped material M1 supplied from the raw material supply portion 11 in a gas such as air. The coarsely pulverizing portion 12 includes a pair of coarsely pulverizing blades 121 and a hopper 122.

Since the coarsely pulverizing blades 121 described above are rotated in opposite directions, the sheet-shaped material M1 is coarsely pulverized therebetween, that is, the sheet-shaped material M1 is cut into coarsely pulverized pieces M2 thereby. The shape and the size of the coarsely pulverized pieces M2 are preferably suitable for a defibrating treatment performed in the defibrating portion 13; hence, for example, small pieces having a length of 100 mm or less are preferable, and small pieces having a length of 10 to 70 mm are more preferable.

The hopper 122 is disposed under the pair of coarsely pulverizing blades 121 and has, for example, a funnel shape. Accordingly, the hopper 122 is able to receive the coarsely pulverized pieces M2 which are coarsely pulverized by the coarsely pulverizing blades 121 to fall down.

In addition, above the hopper 122, the humidifying portion 231 is disposed adjacent to the pair of coarsely pulverizing blades 121. The humidifying portion 231 is a portion to humidify the coarsely pulverized pieces M2 in the hopper 122. Since this humidifying portion 231 has a filter containing moisture (not shown) and allows air to pass through this filter, this humidifying portion 231 is configured to function as a vapor type humidifier to supply humidified air having a high humidity to the coarsely pulverized pieces M2. Since the humidified air is supplied to the coarsely pulverized pieces M2, the coarsely pulverized pieces M2 are suppressed from being adhered to the hopper 122 and the like by static electricity.

The hopper 122 is coupled to the defibrating portion 13 through a pipe 241 used as a flow path. The coarsely pulverized pieces M2 collected by the hopper 122 are transported to the defibrating portion 13 through the pipe 241.

The defibrating portion 13 is a portion to perform the defibrating step of defibrating the coarsely pulverized pieces M2 in a gas, such as air, that is, in a dry environment. By the defibrating treatment performed in this defibrating portion 13, defibrated pieces M3 can be formed from the coarsely pulverized pieces M2. In addition, “to defibrate” indicates that the coarsely pulverized pieces M2 formed from cellulose fibers bound to each other are disentangled into separate fibers. In addition, the pieces thus disentangled are the defibrated pieces M3. The shape of the defibrated piece M3 is a linear shape or a belt shape. In addition, the defibrated pieces M3 may be intertwined into clusters, that is, may be present in the form of so-called “damas”.

For example, in this embodiment, the defibrating portion 13 is formed of an impellor mill having a high-speed rotating rotor and a liner located along an outer circumference thereof. The coarsely pulverized pieces M2 flowing in the defibrating portion 13 are sandwiched between the rotor and the liner and are then defibrated.

In addition, by the rotation of the rotor, the defibrating portion 13 is able to generate a flow of air, that is, an airflow, from the coarsely pulverizing portion 12 toward the sorting portion 14. Accordingly, the coarsely pulverized pieces M2 can be sucked in the defibrating portion 13 through the pipe 241. In addition, after the defibrating treatment, the defibrated pieces M3 can be transported to the sorting portion 14 through a pipe 242.

A blower 261 is provided at a predetermined position of the pipe 242. The blower 261 is an airflow generator to generate an airflow toward the sorting portion 14. Accordingly, the transport of the defibrated pieces M3 to the sorting portion 14 is promoted.

The sorting portion 14 is a portion to perform the sorting step of sorting the defibrated pieces M3 by the lengths of the cellulose fibers. In the sorting portion 14, the defibrated pieces M3 are sorted into a first sorted material M4-1 and a second sorted material M4-2 larger than the first sorted material M4-1. The first sorted material M4-1 has a size suitable for the subsequent manufacturing of a sheet S. The second sorted material M4-2 includes for example, insufficiently defibrated pieces and cellulose fibers which are defibrated and excessively aggregated.

The sorting portion 14 includes a drum section 141 and a housing section 142 to receive the drum section 141.

The drum section 141 is formed of a cylindrical net and is a sieve to be rotated around the central axis thereof. The defibrated pieces M3 flow in this drum section 141. In addition, since the drum section 141 is rotated, defibrated pieces M3 smaller than the opening of the net are sorted as the first sorted material M4-1, and defibrated pieces M3 larger than the opening of the net are sorted as the second sorted material M4-2. The first sorted material M4-1 falls down from the drum section 141.

On the other hand, the second sorted material M4-2 is transported to a pipe 243 which is a flow path connected to the drum section 141. The pipe 243 is connected upstream, that is, at a side opposite to the drum section 141, to the pipe 241. The second sorted material M4-2 passing through this pipe 243 joins the coarsely pulverized pieces M2 in the pipe 241 and flows in the defibrating portion 13 together with the coarsely pulverized pieces M2. Accordingly, the second sorted material M4-2 is returned to the defibrating portion 13 and is then processed by the defibrating treatment together with the coarsely pulverized pieces M2.

In addition, while being dispersed in air, the first sorted material M4-1 falls down from the drum section 141 toward the first web forming portion 15 functioning as a separation portion located under the drum section 141. The first web forming portion 15 is a portion to perform the first web forming step of forming a first web M5 from the first sorted material M4-1. The first web forming portion 15 includes a mesh belt 151 functioning as a separation belt, three tension rollers 152, and a suction section 153.

The mesh belt 151 is an endless belt, and the first sorted material M4-1 is deposited thereon. This mesh belt 151 is stretched around the three tension rollers 152. In addition, by a rotational drive of the tension rollers 152, the first sorted material M4-1 on the mesh belt 151 is transported downstream.

The first sorted material M4-1 has a size larger than the opening of the mesh belt 151. Accordingly, since being restricted to pass through the mesh belt 151, the first sorted material M4-1 can be deposited on the mesh belt 151. In addition, while being deposited on the mesh belt 151, the first sorted material M4-1 is transported downstream together with the mesh belt 151, and hence a layered first web M5 is formed.

In addition, the first sorted material M4-1 may be contaminated, for example, with dust and dirt in some cases. The dust and dirt may be mixed together with the sheet-shaped material M1, for example, when the sheet-shaped material M1 is supplied from the raw material supply portion 11 to the coarsely pulverizing portion 12. The dust and dirt are smaller than the opening of the mesh belt 151. Hence, the dust and dirt pass through the mesh belt 151 and further fall down.

The suction section 153 is able to suck air from under the mesh belt 151. Accordingly, the dust and dirt passing through the mesh belt 151 can be sucked together with air.

In addition, the suction section 153 is coupled to a recovery section 27 through a pipe 244 functioning as a flow path. The dust and dirt sucked in the suction section 153 are recovered by the recovery section 27.

To the recovery section 27, a pipe 245 functioning as a flow path is further connected. In addition, at a predetermined position of the pipe 245, a blower 262 is provided. By the operation of this blower 262, a suction force can be generated in the suction section 153. Accordingly, the formation of the first web M5 on the mesh belt 151 is promoted. From this first web M5, the dust and dirt are removed. In addition, by the operation of the blower 262, the dust and dirt reach the recovery section 27 after passing through the pipe 244.

The housing section 142 is coupled to the humidifying portion 232. The humidifying portion 232 is formed of a vapor type humidifier similar to that of the humidifying portion 231. Accordingly, in the housing section 142, humidified air is supplied. By this humidified air, the first sorted material M4-1 can be humidified, and hence, the first sorted material M4-1 can also be prevented from being adhered to an inner wall of the housing section 142 by static electricity.

A humidifying portion 235 is provided downstream of the sorting portion 14. The humidifying portion 235 is formed of an ultrasonic type humidifier to spray water. Accordingly, moisture can be supplied to the first web M5, and hence, a moisture amount of the first web M5 can be adjusted. By this adjustment, the adsorption of the first web M5 to the mesh belt 151 by static electricity can be suppressed. Accordingly, the first web M5 can be easily peeled away from the mesh belt 151 at a position at which the mesh belt 151 is folded by the tension roller 152.

The subdividing portion 16 is disposed downstream of the humidifying portion 235. The subdividing portion 16 is a portion to perform the subdividing step of subdividing the first web M5 peeled away from the mesh belt 151. The subdividing portion 16 includes a rotatably supported propeller 161 and a housing section 162 to receive the propeller 161. In addition, since being brought into contact with the rotating propeller 161, the first web M5 can be subdivided. The first web M5 is subdivided into subdivided pieces M6. In addition, the subdivided pieces M6 fall down in the housing section 162.

The housing section 162 is coupled to the humidifying portion 233. The humidifying portion 233 is formed of a vapor type humidifier similar to that of the humidifying portion 231. Accordingly, in the housing section 162, humidified air is supplied. By this humidified air, the subdivided pieces M6 can also be suppressed from being adhered to the propeller 161 and an inner wall of the housing section 162 by static electricity.

The mixing portion 17 is disposed downstream of the subdividing portion 16. The mixing portion 17 is a portion to perform the mixing step of mixing the subdivided pieces M6 and the composite body C10 described above. This mixing portion 17 includes a composite body supply section 171, a pipe 172 functioning as a flow path, and a blower 173.

The pipe 172 couples the housing section 162 of the subdividing portion 16 to a housing section 182 of the loosing portion 18 and functions as a flow path through which a mixture M7 of the subdivided pieces M6 and the composite body C10 passes.

The composite body supply section 171 is connected to the pipe 172 at a predetermined position. The composite body supply section 171 includes a screw feeder 174. Since this screw feeder 174 is rotatory driven, the composite body C10 can be supplied to the pipe 172. The composite body C10 supplied to the pipe 172 is mixed with the subdivided pieces M6 to form the mixture M7.

In addition, from the composite body supply section 171, for example, an aggregation inhibitor which inhibits aggregation of the cellulose fibers and that of the composite body C10 and a flame retardant which makes the cellulose fibers or the like difficult to burn may also be supplied together with the composite body C10.

In addition, at a predetermined position of the pipe 172, the blower 173 is disposed downstream than the composite body supply section 171. The blower 173 is able to generate an airflow toward the loosing portion 18. By this airflow, in the pipe 172, the subdivided pieces M6 and the composite body C10 can be mixed together. Accordingly, the mixture M7 in the state in which the subdivided pieces M6 and the composite body C10 are uniformly dispersed can flow in the loosing portion 18. In addition, while the mixture M7 passes through the pipe 172, the subdivided pieces M6 in the mixture M7 are loosened into finer fibers.

The loosing portion 18 is a portion to perform the loosing step of loosing the cellulose fibers entangled with each other in the mixture M7. The loosing portion 18 has a drum section 181 and the housing section 182 to receive the drum section 181.

The drum section 181 is formed of a cylindrical net and is a sieved to be rotated around the central axis thereof. Into this drum section 181, the mixture M7 flows. In addition, since the drum section 181 is rotated, of the mixture M7, for example, cellulose fibers smaller than the opening of the net are able to pass through the drum section 181. In this case, the mixture M7 is to be loosed.

In addition, while being dispersed in air, the mixture M7 loosed in the drum section 181 falls down toward the second web forming portion 19 located under the drum section 181. The second web forming portion 19 is a portion to perform the second web forming step of forming a second web M8 from the mixture M7. In this embodiment, the second web forming step is a deposition step of depositing the mixture containing the cellulose fibers and the composite body C10 by an airflow. The second web forming portion 19 includes a mesh belt 191 functioning as a separation belt, tension rollers 192, and a suction section 193.

The mesh belt 191 is an endless belt, and the mixture M7 is deposited thereon. The mesh belt 191 is stretched around the four tension rollers 192. In addition, by a rotational drive of the tension rollers 192, the mixture M7 on the mesh belt 191 is transported downstream.

In addition, most of the mixture M7 on the mesh belt 191 has a size larger than the opening of the mesh belt 191. Accordingly, the mixture M7 is restricted to pass through the mesh belt 191 and hence, can be deposited on the mesh belt 191. In addition, while depositing on the mesh belt 191, the mixture M7 is transported downstream with the mesh belt 191, and hence, a layered second web M8 is formed.

The suction section 193 is able to suck air from under the mesh belt 191. Accordingly, the mixture M7 can be sucked on the mesh belt 191, and hence, the deposition of the mixture M7 on the mesh belt 191 is promoted.

To the suction section 193, a pipe 246 functioning as a flow path is connected. In addition, at a predetermined position of this pipe 246, a blower 263 is disposed. By the operation of this blower 263, a suction force can be generated in the suction section 193.

The housing section 182 is coupled to the humidifying portion 234. The humidifying portion 234 is formed of a vapor type humidifier similar to that of the humidifying portion 231. Accordingly, in the housing section 182, humidified air is supplied. By this humidified air, the inside of the housing section 182 is humidified, and hence, the mixture M7 can also be prevented from being adhered to an inner wall of the housing section 182 by static electricity.

A transport section 195 is disposed downstream in the transport direction of the second web M8 on the mesh belt 191. After the second web M8 on the mesh belt 191 is peeled away therefrom, the transport section 195 transports the second web M8 toward a pressure section 201. The transport section 195 includes a mesh belt 195a, tension rollers 195b, and a suctioner 195c. The mesh belt 195a is stretched around the tension rollers 195b so as to allow air to pass therethrough. The mesh belt 195a is configured so as to be transferred by rotation of the tension rollers 195b. The suctioner 195c is disposed so as to face the second web M8 with the mesh belt 195a interposed therebetween. The suctioner 195c includes a blower and generates an upward airflow toward the mesh belt 195a by a suction force of the blower. By this airflow, the second web M8 is sucked.

Accordingly, the second web M8 is peeled away from the mesh belt 191, and a surface of the second web M8 opposite to the surface peeled away from the mesh belt 191 can be adsorbed to the mesh belt 195a. The second web M8 adsorbed to the mesh belt 195a is transported while being in contact with the mesh belt 195a.

A humidifying portion 236 is disposed under the transport section 195. The humidifying portion 236 is a portion to perform the humidifying step described above to apply moisture to the second web M8 in contact with the mesh belt 195a. Accordingly, moisture can be supplied to the second web M8, and hence, a moisture amount of the second web M8 can be adjusted. By this adjustment, a binding force between a binding material and the cellulose fibers in a sheet S as a colored fiber body to be finally obtained can be made preferable. In addition, the adsorption of the second web M8 to the mesh belt 195a by static electricity can be suppressed. In the humidifying portion 236, as the moisture, for example, water vapor or mist is applied to the second web M8. Accordingly, moisture can be uniformly applied to the second web M8.

The humidifying portion 236 applies moisture from under the second web M8. The humidifying portion 236 may be a portion including, for example, a container capable of storing water and a piezoelectric oscillator disposed at a bottom of the container described above. For example, an upper part of the container is opened, and the container is disposed so that this opening faces a second web M8 side. When the piezoelectric oscillator is driven, ultrasonic waves are generated in water, mist is generated in the above container, and the mist thus generated is supplied to the second web M8 through the opening of the container. Since the moisture is applied from under the second web M8, even if dewdrops are generated on the humidifying portion 236 and in the vicinity thereof, no water droplets fall down on the second web M8. That is, for example, in the case in which moisture is applied to the second web M8 from an upper side, moisture is adhered to the humidifying portion 236 and in the vicinity thereof, and hence, the moisture in the form of water droplets may be adhered to the web when falling down. In the case described above, although the moisture is unevenly applied to the second web M8, by the structure as described above, for example, the falling of the water droplets is suppressed, and hence, the influence on the quality of the sheet S as the colored fiber body can be effectively prevented.

In addition, the suctioner 195c of the transport section 195 is disposed so as to face the humidifying portion 236 with the mesh belt 195a interposed therebetween. Accordingly, by the suctioner 195c, an airflow containing moisture generated in the humidifying portion 236 passes through the inside of the second web M8, so that the moisture can be applied to the inside of the second web M8. Accordingly, the suctioner 195c described above can be responsible for both a function in which the second web M8 is peeled away form the mesh belt 191 and is then adsorbed to the mesh belt 195a and a function in which moisture is applied to the inside of the second web M8. Hence, the structure of the sheet manufacturing apparatus 100 can be simplified.

Since moisture is applied from the surface of the second web M8 opposite to the surface in contact with the mesh belt 195a, the second web M8 can be transported while the surface of the second web M8 in contact with the mesh belt 195a has a weak adhesion compared to that of the surface opposite thereto. Hence, the second web M8 to which the moisture is applied can be suppressed from being adhered to the mesh belt 195a.

The sheet forming portion 20 is disposed downstream of the second web forming portion 19. The sheet forming portion 20 is a portion to perform the sheet forming step which is a molding step to form the sheet S from the second web M8. This sheet forming portion 20 includes a pressure section 201 and a heating section 202.

The pressure section 201 includes a pair of calendar rollers 203, and between the rollers 203, the second web M8 cab be pressurized without heating. Accordingly, the density of the second web M8 can be increased. In addition, this second web M8 is transported to the heating section 202. In addition, one of the pair of calendar rollers 203 is a drive roller to be driven by an operation of a motor (not shown), and the other roller is a driven roller.

The heating section 202 includes a pair of heating rollers 204, and between the rollers 204, the second web M8 can be pressurized while being heated. By this heating and pressure application, in the second web M8, the composite body C10 is melted, and the cellulose fibers are bound to each other with the melted composite body C10 interposed therebetween. Accordingly, the sheet S as the colored fiber body is formed. In addition, this sheet S is transported toward the cutting portion 21. In addition, one of the pair of heating rollers 204 is a drive roller driven by an operation of a motor (not shown), and the other roller is a driven roller.

The cutting portion 21 is disposed downstream of the sheet forming portion 20. The cutting portion 21 is a portion to perform the cutting step of cutting the sheet S. This cutting portion 21 includes a first cutter 211 and a second cutter 212.

The first cutter 211 is a cutter to cut the sheet S in a direction intersecting the transport direction of the sheet S.

The second cutter 212 is a cutter disposed downstream of the first cutter 211 to cut the sheet S in a direction parallel to the transport direction of the sheet S.

By the cutting using the first cutter 211 and the second cutter 212 as described above, a sheet S as a colored fiber body having a desired size is obtained. In addition, this sheet S is further transported downstream and is then stacked in the stock portion 22.

### 3. Colored Fiber Body

Next, the colored fiber body according to the present disclosure will be described.

The colored fiber body according to the present disclosure is manufactured using the method for manufacturing a colored fiber body of the present disclosure described above.

Accordingly, a colored fiber body containing cellulose fibers and having an excellent strength can be provided.

Individual components contained in the colored fiber body according to the present disclosure are preferably components which satisfy conditions similar to those described in the above 1-1-1, 1-1-2-1-1, and 1-1-2-1-2.

Although the shape of the colored fiber body according to the present disclosure is not particularly limited, and any one of a sheet shape, a block shape, a spherical shape, a three-dimensional shape, and the like may be used, the colored fiber body according to the present disclosure preferably has a sheet shape. In addition, the sheet shape described above indicates a colored fiber body molded to have a thickness of 30 μm to 30 mm and a density of 0.05 to 1.5 g/cm³.

Accordingly, for example, the colored fiber body may be preferably used as a recording medium. In addition, when the apparatus as described above is used, the colored fiber body can be more efficiently manufactured.

When the colored fiber body according to the present disclosure is a sheet-shaped recording medium, the thickness thereof is preferably 30 μm to 3 mm.

Accordingly, the colored fiber body can be more preferably used as a recording medium. In addition, when the apparatus as described above is used, the colored fiber body can be more efficiently manufactured.

When the colored fiber body according to the present disclosure is a sheet-shaped recording medium, the density thereof is preferably 0.6 to 0.9 g/cm³.

Accordingly, the colored fiber body can be more preferably used as a recording medium.

The colored fiber body according to the present disclosure may include at least part thereof which is manufactured using the method for manufacturing a colored fiber body of the present disclosure described above and may further include another part other than that described above. In addition, after the steps of the method for manufacturing a colored fiber body of the present disclosure are performed, a post-treatment may also be performed.

The application of the colored fiber body according to the present disclosure is not particularly limited, and for example, a recording medium, a liquid absorber, a buffer material, or an acoustic absorbent may be mentioned.

Heretofore, although preferable embodiments of the present disclosure have been described, the present disclosure is not limited thereto.

For example, in the embodiment described above, although the case in which the composite body includes the composite particles each containing the binding material/colorant-containing particle and the inorganic particles adhered to the surface thereof has been primarily described, as long as the composite body includes the composite particles each integrally containing the binding material and the biological-derived colorant, the inorganic particles are not always required to be contained.

In addition, in the embodiment described above, although the case in which the inorganic particles forming the composite body are each formed by a surface treatment using a surface treatment agent on the mother particle formed from an inorganic material has been primarily described, the inorganic particles are not always required to be surface-treated by the surface treatment agent. In the case described above, the inorganic particles are preferably particles which satisfy conditions similar to those described in the above 1-1-2-1-2-1.

In addition, the portions forming the sheet manufacturing apparatus each may be replaced by a portion having an arbitrary structure which is able to function similar to that described above. In addition, an arbitrary constituent may also be added.

In addition, the colored fiber body according to the present disclosure is not limited to that manufactured using the apparatus described above and may be manufactured using an arbitrary apparatus.

### EXAMPLES

Next, concrete examples of the present disclosure will be described.

### 4. Preparation of Composite Body

### Example A1

First, after 10.0 parts by mass of a turmeric pigment as a water insoluble biological-derived colorant, 10.0 parts by mass of decaglyceryl myristate as a dispersant for the colorant, and 80.0 parts by mass of water were mixed together, a treatment was performed using a bead mill, so that a colorant dispersant liquid was obtained. The treatment using a bead mill was performed with zirconia beads having a diameter of 0.3 mm as a pulverization media at an agitator circumferential velocity of 12 m/s for 60 minutes. An average particle diameter of the turmeric pigment contained in the colorant dispersion liquid thus obtained was 185 μm. In addition, the decaglyceryl myristate was a biological-derived dispersant.

Next, after 40.0 parts by mass of the colorant dispersion liquid obtained as described above, 18.0 parts by mass of a starch having a weight average molecular weight of 80,000 as a binding material, 18.0 parts by mass of erythritol as a biological-derived plasticizer, and 324.0 parts by mass of water were mixed together in a beaker, the beaker receiving the mixture liquid thus obtained was placed in a microwave oven and irradiated with microwaves at 600 W for 4 minutes, so that a gelatinization liquid was obtained.

The gelatinization liquid obtained as described above was dried by a spray drier, so that an aggregate of binding material/colorant-containing particles having an average particle diameter of 5.3 μm was obtained.

Subsequently, after this aggregate of binding material/colorant-containing particles was filled in a Henschel mixer (FM mixer (FM 20C/I), manufactured by Nippon Coke & Engineering Co., Ltd.), with respect to 100 parts by mass of the aggregate of binding material/colorant-containing particles, one part by mass of a fumed silica (DM-10, manufactured by Tokuyama Corporation) as inorganic particles having a dimethyl silyl group on its surface was added, and a stirring treatment was performed at a rotation rate of 6,000 rpm for one hour, so that a composite body was prepared.

The composite body obtained as described above was a composite body including composite particles in each of which the fumed silica used as the inorganic particles were adhered to the surfaces of the starch particles as the binding material/colorant-containing particles. An average particle diameter of the inorganic particles contained in the composite body was 14 nm, and an average particle diameter of the binding material/colorant-containing particles contained in the composite body was 3.0 μm.

### Examples A2 to A4

Except for that the types and the use amounts of the components used for the preparation of the colorant dispersion liquid were changed as shown in Table 1, and the use amounts of the components used for the preparation of the gelatinization liquid were changed as shown in Table 2, a composite body was prepared in a manner similar to that in the above Example A1.

### Example A5

First, 20.0 parts by mass of a blue gardenia pigment as a water soluble biological-derived colorant and 80.0 parts by mass of water were mixed together, so that a colorant solution was obtained.

Next, after 20.0 parts by mass of the colorant solution obtained as described above, 18.0 parts by mass of a starch having a weight average molecular weight of 200,000 as a binding material, 18.0 parts by mass of erythritol as a biological-derived plasticizer, and 344.0 parts by mass of water were mixed together in a beaker, the beaker receiving this mixture liquid was placed in a microwave oven and then irradiated by microwaves at 600 W for 4 minutes, so that a gelatinization liquid was obtained.

The gelatinization liquid thus obtained was dried by a spray drier, so that an aggregate of binding material/colorant-containing particles having an average particle diameter of 10.2 μm was obtained.

Subsequently, after this aggregate of binding material/colorant-containing particles was filled in a Henschel mixer (FM mixer (FM 20C/I), manufactured by Nippon Coke & Engineering Co., Ltd.), one part by mass of a fumed silica (DM-10, manufactured by Tokuyama Corporation) as inorganic particles having a dimethylsilyl group on its surface was added with respect to 100 parts by mass of the aggregate of binding material/colorant-containing particles, and a stirring treatment was then performed at a rotation rate of 6,000 rpm for one hour, so that a composite body was prepared.

The composite body obtained as described above was a composite body including composite particles in each of which the fumed silica used as the inorganic particles was adhered to the surfaces of the starch particles as the binding material/colorant-containing particles. An average particle diameter of the inorganic particles included in the composite body was 14 nm, and an average particle diameter of the binding material/colorant-containing particles included in the composite body was 3.0 μm.

### Examples A6 and A7

Except for that the types and the use amounts of the components used for the preparation of the colorant solution were changed as shown in Table 1, and the use amounts of the components used for the preparation of the gelatinization liquid were changed as shown in Table 2, a composite body was prepared in a manner similar to that in the above Example A5.

The compositions of the colorant dispersion liquids and the colorant solutions used for the preparation of the composite bodies of the respective Examples are collectively shown in Table 1, and the components of the gelatinization liquids used for the preparation of the composite bodies of the respective Examples are collectively shown in Table 2. In addition, in the respective Examples, a rate of the binding material/colorant-containing particles forming the composite particles to all the binding material/colorant-containing particles contained in the composite body was 90 percent by mass or more, and a rate of the inorganic particles forming the composite particles to all the inorganic particles contained in the composite body was 90 percent by mass or more.

TABLE 1

| | BIOLOGICAL-DERIVED | | | | |
|---|---|---|---|---|---|
| | COLORANT | | DISPERSANT | | WATER |
| | | USE | | USE | USE |
| | | AMOUNT | | AMOUNT | AMOUNT |
| | | (PARTS BY | | (PARTS BY | (PARTS BY |
| | TYPE | MASS) | TYPE | MASS) | MASS) |
| EXAMPLE A1 | TURMERIC PIGMENT | 10.0 | DECAGLYCERYL | 10.0 | 80.0 |
| | | | MYRISTATE | | |
| EXAMPLE A2 | BINCHO CHARCOAL | 10.0 | SODIUM LIGNIN | 15.0 | 75.0 |
| | | | SULFONATE | | |
| EXAMPLE A3 | LAC PIGMENT | 8.0 | DECAGLYCERYL | 8.0 | 84.0 |
| | | | MYRISTATE | | |
| EXAMPLE A4 | INDIGO BLUE | 8.0 | DECAGLYCERYL | 8.0 | 84.0 |
| | | | MYRISTATE | | |
| EXAMPLE A5 | GARDENIA BLUE | 20.0 | — | — | 80.0 |
| | PIGMENT | | | | |
| EXAMPLE A6 | GARDENIA YELLOW | 20.0 | — | — | 80.0 |
| | PIGMENT | | | | |
| EXAMPLE A7 | GARDENIA RED | 20.0 | — | — | 80.0 |
| | PIGMENT | | | | |

TABLE 2

| | COLORANT | | | | | | |
|---|---|---|---|---|---|---|---|
| | DISPERSION LIQUID | | | | | | |
| | OR COLORANT | | BINDING | | | | |
| | SOLUTION | | MATERIAL | | PLASTICIZER | | WATER |
| | | USE | | USE | | USE | USE |
| | | AMOUNT | | AMOUNT | | AMOUNT | AMOUNT |
| | | (PARTS | | (PARTS | | (PARTS | (PARTS |
| | | BY | | BY | | BY | BY |
| | TYPE | MASS) | TYPE | MASS) | TYPE | MASS) | MASS) |
| EXAMPLE B1 | EXAMPLE A1 | 40.0 | STARCH | 18.0 | ERYTHRITOL | 18.0 | 324.0 |
| EXAMPLE B2 | EXAMPLE A2 | 40.0 | STARCH | 18.0 | ERYTHRITOL | 18.0 | 324.0 |
| EXAMPLE B3 | EXAMPLE A3 | 40.0 | STARCH | 18.0 | ERYTHRITOL | 18.0 | 324.0 |
| EXAMPLE B4 | EXAMPLE A4 | 40.0 | STARCH | 18.0 | ERYTHRITOL | 18.0 | 324.0 |
| EXAMPLE B5 | EXAMPLE A5 | 20.0 | STARCH | 18.0 | ERYTHRITOL | 18.0 | 344.0 |
| EXAMPLE B6 | EXAMPLE A6 | 20.0 | STARCH | 18.0 | ERYTHRITOL | 18.0 | 344.0 |
| EXAMPLE B7 | EXAMPLE A7 | 20.0 | STARCH | 18.0 | ERYTHRITOL | 18.0 | 344.0 |
| EXAMPLE B8 | EXAMPLE A1 | 4.0 | STARCH | 18.0 | ERYTHRITOL | 18.0 | 360.0 |
| EXAMPLE B9 | EXAMPLE A5 | 2.0 | STARCH | 18.0 | — | 0 | 380.0 |

### 5. Manufacturing of Sheet as Colored Fiber Body Example B1

In this Example, a sheet as the colored fiber body was manufactured as described below using the composite body prepared in the above Example A1.

First, a sheet manufacturing apparatus as shown in FIG. 2 was prepared, and commercial copy paper (GR70-W, manufactured by Fuji Xerox Co., Ltd.) as a cellulose fiber source was prepared as a sheet-shaped material.

Next, after the sheet-shaped material described above was supplied to a raw material supply portion of the sheet manufacturing apparatus, and in addition, the composite body prepared in the above Example A1 was supplied to a composite body supply section so as to drive the sheet manufacturing apparatus, a process including a coarsely pulverizing step, a defibrating step, a sorting step, a first web forming step, a subdividing step, a mixing step, a loosing step, a second web forming step functioning as a deposition step, a humidifying step, a sheet forming step functioning as a molding step, and a cutting step was performed, so that a sheet having an A4 size was manufactured as the colored fiber body. The sheet thus obtained had a basis weight of 90 g/m². In addition, the sheet obtained as described above had, by visual inspection, a uniform yellow color with no color irregularity.

In the case described above, a sheet as a colored fiber body to be finally obtained was adjusted so that as the raw material, 10 parts by mass of the composite body was contained with respect to 90 parts by mass of the cellulose fibers. In addition, in the humidifying step, with respect to 100 parts of a mixture to be subjected to the humidifying step, a moisture amount to be applied was adjusted to be 20 parts by mass. In addition, when the heating and the pressurizing were performed in a heating section, a heating temperature was set to 80° C., a pressure was set to 70 MPa, and a heating and pressuring time was set to 15 seconds.

### Examples B2 to B9

Except for that composition shown in Table 2 was used as the composite body, a sheet having an A4 size was manufactured as the colored fiber body in a manner similar to that of the above Example B1. The sheets obtained in Examples B2 to B9 each had no color irregularity by visual inspection. In particular, the sheet obtained in Example B2 had a black color, the sheet obtained in Example B3 had a red color, the sheet obtained in Example B4 had an indigo color, the sheet obtained in Example B5 had a blue color, the sheet obtained in Example B6 had a yellow color, and the sheet obtained in Example B7 had a red color.

### 6. Evaluation

### 6-1. Strength of Colored Fiber Body

From the sheets manufactured in the above Examples B1 to B9 as the colored fiber bodies were each cut into a rectangular shape having a size of 100 mm×20 mm, and a rupture strength of the rectangular shape in a longitudinal direction was measured. For the measurement of the rupture strength, an Autograph AGS-1N manufactured by Shimadzu Corporation was used, and after the rupture strength was measured at a tensile rate of 20 mm/sec, a specific tensile strength was calculated therefrom and then evaluated in accordance with the following criteria. As the specific tensile strength is increased, the strength is considered to be improved.
A: specific tensile strength is 25 Nm/g or more.
B: specific tensile strength is 20 to less than 25 Nm/g.
C: specific tensile strength is 15 to less than 20 Nm/g.
D: specific tensile strength is 10 to less than 15 Nm/g.
E: specific tensile strength is less than 10 Nm/g.

### 6-2. Fluidity

The repose angle and the degree of compaction of the composite body used for the manufacturing of the colored fiber body of each of the above Examples B1 to B9 were measured using a powder characteristics tester (Powder Tester PT-X, manufactured by Hosokawa Micron Corporation).

From the measurement results, a fluidity value which is the product of the repose angle [° ] and the degree of compaction [%] was obtained and then evaluated in accordance with the following criteria. As the fluidity value is decreased, the fluidity is considered to be improved.
A: Fluidity value is less than 10.
B: Fluidity value is 10 to less than 12.
C: Fluidity value is 12 to less than 14.
D: Fluidity value is 14 to less than 17.
E: Fluidity value is 17 or more.

Those results are collectivity shown in Table 3.

TABLE 3

| | STRENGTH | FLUIDITY |
|---|---|---|
| EXAMPLE B1 | A | A |
| EXAMPLE B2 | A | A |
| EXAMPLE B3 | A | A |
| EXAMPLE B4 | A | A |
| EXAMPLE B5 | A | A |
| EXAMPLE B6 | A | A |
| EXAMPLE B7 | A | A |

As apparent from Table 3, according to the present disclosure, excellent results can be obtained. In addition, in each of the above Examples B1 to B9, the colorant used as the raw material can be efficiently used, and the colorant thus used is not discharged out of the sheet manufacturing apparatus in the form of a structural component other than that of the sheet, such as a waste liquid.

In addition, except for that the mixing rate between the cellulose fibers and the composite body in the deposition step was variously changed so that the content of the composite body in the mixture obtained in the deposition step was 1 to 50 percent by mass, the sheet as the colored fiber body was manufactured in a manner similar to that of each of the above Examples B1 to B9. Subsequently, when the sheet thus obtained was evaluated in a manner similar to that described above, a result similar to that described above was obtained.

In addition, except for that an application amount of moisture to the second web formed by depositing the mixture of the cellulose fibers and the composite body, that is, a moisture amount to be applied to the mixture in the humidifying step, was variously changed so that a water content in the mixture at the end of the humidifying step was 12 to 40 percent by mass, the sheet as the colored fiber body was manufactured in a manner similar to that of each of the above Examples B1 to B9. Subsequently, when the sheet thus obtained was evaluated in a manner similar to that described above, a result similar to that described above was obtained.

In addition, except for that the heating temperature in the molding step was variously changed in a range of 60° C. to 250° C., the sheet as the colored fiber body was manufactured in a manner similar to that of each of the above Examples B1 to B9. Subsequently, when the sheet thus obtained was evaluated in a manner similar to that described above, a result similar to that described above was obtained.

In addition, except for that the pressure applied to the mixture in the molding step was variously changed in a range of 0.1 to 100 MPa, the sheet as the colored fiber body was manufactured in a manner similar to that of each of the above Examples B1 to B9. Subsequently, when the sheet thus obtained was evaluated in a manner similar to that described above, a result similar to that described above was obtained.

In addition, except for that the heating and pressurizing time in the molding step was variously changed in a range of 1 to 60 seconds, the sheet as the colored fiber body was manufactured in a manner similar to that of each of the above Examples B1 to B9. Subsequently, when the sheet thus obtained was evaluated in a manner similar to that described above, a result similar to that described above was obtained.

What is claimed is:

1. A method for manufacturing a colored fiber body, the method comprising:
a deposition step of depositing a mixture containing cellulose fibers and a composite body by an airflow;
a humidifying step of humidifying the mixture; and
a molding step of heating and pressurizing the humidified mixture to form a fiber body,
wherein the composite body includes composite particles which integrally contain a biological-derived colorant and a binding material to have a binding force to bind the cellulose fibers to each other by moisture application.

2. The method for manufacturing a colored fiber body according to claim 1,
wherein the binding material include a starch.

3. The method for manufacturing a colored fiber body according to claim 1,
wherein the biological-derived colorant is water soluble.

4. The method for manufacturing a colored fiber body according to claim 1,
wherein the biological-derived colorant is water insoluble.

5. The method for manufacturing a colored fiber body according to claim 4,
wherein the composite particles further contain a dispersant for the biological-derived colorant.

6. The method for manufacturing a colored fiber body according to claim 5,
wherein the dispersant includes a biological-derived dispersant.

7. The method for manufacturing a colored fiber body according to claim 1,
wherein the composite particles further contain inorganic particles.

8. The method for manufacturing a colored fiber body according to claim 1,
wherein the composite particles further contain a plasticizer.

9. The method for manufacturing a colored fiber body according to claim 8,
wherein the plasticizer includes a biological-derived plasticizer.

10. The method for manufacturing a colored fiber body according to claim 1,
wherein the composite particles have an average particle diameter of 1.0 to 50 μm.

11. The method for manufacturing a colored fiber body according to claim 1,
wherein the mixture to be subjected to the molding step has a water content of 12 to 40 percent by mass.

12. A composite body used for manufacturing of a colored fiber body including cellulose fibers, the composite body comprising:
composite particles which integrally contain a biological-derived colorant and a binding material to have a binding force to bind the cellulose fibers to each other by moisture application.
